(19) United States
(12) Patent Application Publication
(10) Pub. No.: US 2008/0000401 A1
(43) Pub. Date: Jan. 3, 2008

(54) Locking door for security drawer

(76) Inventors: Jack Weaver, Cypress, TX (US); Brian K. Coble, Houston, TX (US); Shawn Grill, Spring, TX (US)

Correspondence Address: TROP PRUNER & HU, PC, 1616 S. VOSS ROAD, SUITE 750, HOUSTON, TX, 77057-2631, US

(21) Appl. No.: 11/477,225

(22) Filed: Jun. 29, 2006

(51) Int. Cl. E06B 7/32

(52) U.S. Cl. 109/19

(57) ABSTRACT

A security drawer may be provided with an upwardly opening door. The upward opening of the door may be prevented when the drawer is not in use by the locking in position of a cover plate between a lock bar and the upper edge of the drawer door. As a result, any attempt to break into the security drawer may be thwarted and the door is forcefully locked against intruders.

### BACKGROUND

This relates generally to security drawers. A security drawer enables a person inside a building to provide goods, services, or money to a person outside the building or to receive items from a person outside the building. Security drawers may be utilized to receive money and to provide pharmaceuticals, consumer products, or other items.

Typical applications of security drawers are drug stores, banks, convenience stores, and liquor stores. In each of these cases, merchandise or funds may be provided from the store or other facility to the user and the user may return items, such as money, to complete a transaction.

Ideally, the drawer provides security for the workers inside the facility. It enables them to provide services with a reduced risk for robbery, especially at night and in after-normal business hours operations.

Thus, the security drawer includes an opening which is accessible from inside the building. When the drawer is outwardly extended, an opening is also accessible from outside the building.

### BRIEF DESCRIPTION OF THE DRAWINGS

FIG. 1 is a perspective view of a security drawer partially broken away in the open or extended position; and

FIG. 2 is a partially broken away, perspective view of the security drawer of FIG. 1 in a retracted or closed position.

### DETAILED DESCRIPTION

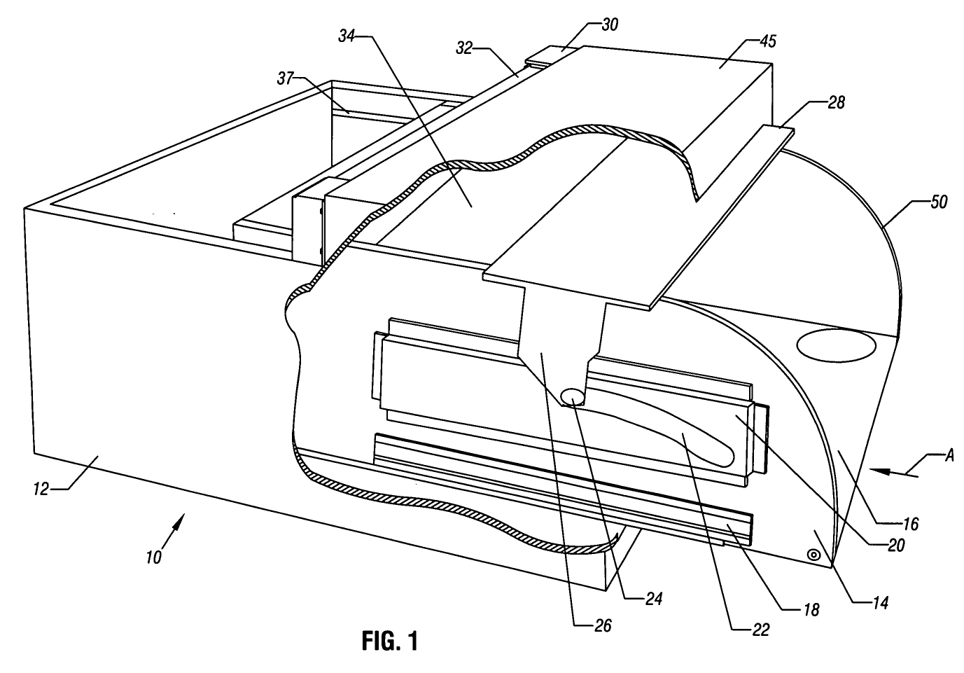

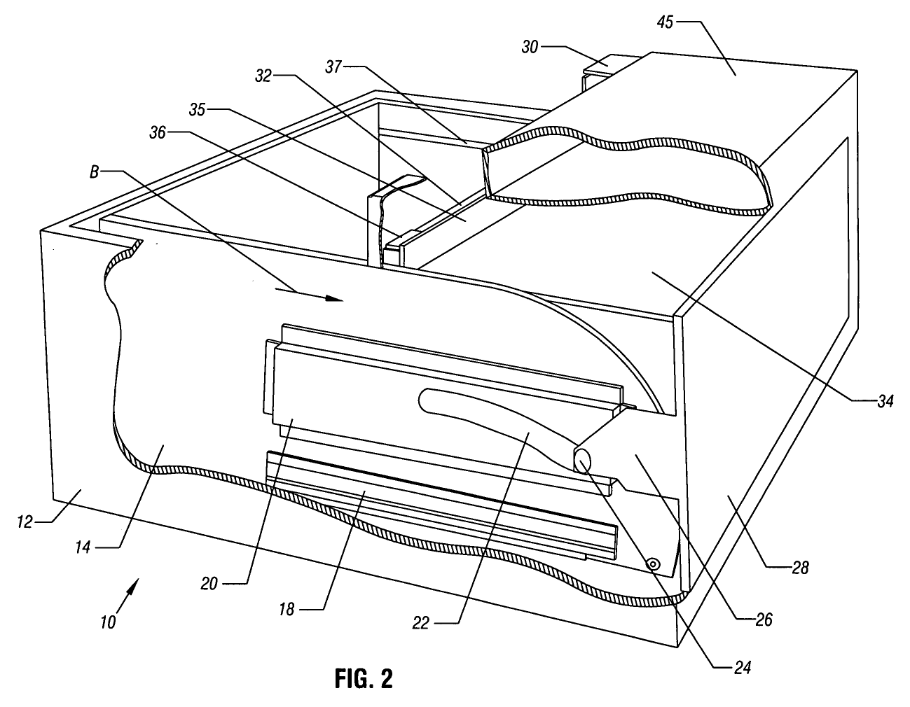

Referring to FIG. 1, a security drawer 10 is shown with the drawer 10 in the opened, extended position. It may be mounted in a facility exterior wall at a height such that the drawer is convenient to a car's driver. FIG. 2 shows the same drawer in the withdrawn and closed position. In the extended position, the consumer can access the interior of the drawer, as indicated at 16, and may place items thereon or take items therefrom. In the closed position, shown in FIG. 2, the consumer is presented with the closed door 28.

An unscrupulous person may attempt to break open the security drawer 10, in the closed position, in order to gain access to the facility, either to take things therefrom or to do harm to people working within the facility. To gain access, a person may attempt to bend or break the door 28 by pushing in, for example, on the upper edge of the door 28.

As shown in FIG. 2, deflection of the closed door 28 is prevented by the plate 34. The plate 34 is a horizontal plate with an upstanding flange 35, shown in FIG. 2. That flange 35 may be locked to prevent inward movement of the plate 34. As a result, the plate 34 is pressed against the upper edge of the closed door 28, preventing any effort to push it inwardly to gain access to the interior of the drawer 10 and, ultimately, the facility.

In order to lock the plate 34, a vertically reciprocating bar 32 may be provided. The bar 32 is shown in its downward position behind the upward flange 35 of the plate 34. In this position, the bar 32 prevents rearward, inward motion of the plate 34 by blocking the plate 34 in position, securing the door 28 in its closed position.

In one embodiment, the bar 32 extends completely across the drawer 10 and has magnetic upper strips 36 (FIG. 2). The strips 36 are provided to secure the bar 32 in its raised position at the top of the U-shaped housing 30.

Referring to FIG. 1, the bar 32 may be releasably held by the magnets 36 in the upper position against the top of a U-shaped metallic housing 30 on two opposed sides of the drawer 10. The housings 30 have open inwardly facing sides. When it is desired to lock the drawer door 28, a person inside the facility can simply press down on the bar 32, breaking the magnetic attraction and positioning the bar so as to block the rearward motion of the plate 34, as shown in FIG. 2. The plate 34 rides on guides 37 on the inside facing surfaces of the tray 14.

Referring to FIG. 1, the drawer 10 includes a housing 12 which may be U-shaped, having an open top and an open outward end. The open outward end allows the tray 14 to reciprocate in and out of the housing 12. To enable this, the tray 14 may ride on a conventional drawer bearing or roller assembly 18 which is mounted on the tray 14 and on the housing 12 to provide inward and outward sliding reciprocation of the tray 14. A header 45 is used to mount the drawer 10 in a building wall.

Referring to FIG. 1, the door 28 is in its raised, horizontal, open position with the tray 14 extended to the external user. The door 28 is connected to the side of the tray 14 through a pivot pin 24 which rides in a cam slot 22 in a bracket 20, mounted on the side of the tray 14. The pin 24 also is mounted in a hole in a flange 26 that transversely connects to the door 28.

As a result of the arcuate shape of the slot 22, the door 28 is automatically opened by a counterclockwise rotation as a result of the outward reciprocation of the tray 14. That reciprocation results in the motion of the pin 24 along the cam slot 22, opening the door 28 as the tray extends outwardly.

Conversely, as the tray 14 returns inwardly, the pin 14 follows the slot 22, closing the door 28 by clockwise rotation. In many cases, a bracket 20, pin 24, flange 26, slot 22, and roller 18 are provided on both laterally opposed sides of the tray 14.

The curved outer edges 50 of the tray 14 guide the opening and closing of the door 28. Namely, as the door 28 rotates from the closed position to the opened, upward, horizontal configuration, the door 20 is guided by the curved edges 50 of the drawer 14.

With the door 28 in the closed position, shown in FIG. 2, the door 28 may be locked by pushing the bar 32 downwardly to a stop. In this position, the magnetic attraction between the top of the frame 30 and the magnet 36 is broken. The vertical flange 35 of the horizontal cover plate 34 is then blocked by the bar 32, preventing its rearward motion.

Conventionally, the horizontal plate 34 reciprocates freely from the rear to the front to simply close off communication when the tray 14 is open and outwardly extended. The cover 34 also provides a blocking, locking action to further prevent forceful opening of the door 28 when the drawer 10 is closed.

In some embodiments of the present invention, the operation of the drawer 10 may be manual. The tray 14 may include a handle (not shown) at its rearward end which is simply pushed outwardly to operate the drawer and to provide service to a customer. In other cases, the drawer 10 may be electrical and the tray 14 may be driven inwardly and outwardly by an appropriate mechanism.

In the open position, shown in FIG. 1, the raised door 28 shields the interior of the tray 14 from the elements and from view. The door 28 may be mounted on the bracket 28 so that it cannot rotate clockwise from the closed position, for example, because of the imposition of the tray 14.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. a method comprising:
providing a sliding security drawer with a lockable, upwardly opening exterior door.

2. The method of claim 1 including providing a sliding plate that abuts against the door.

3. The method of claim 2 including providing a vertically reciprocating bar positionable in a first position to allow the plate to move and a second position to block said plate against said door.

4. The method of claim 3 including providing a retainer to hold the bar in the first position.

5. The method of claim 4 including providing a magnetic retainer.

6. The method of claim 5 including causing said door to open upwardly.

7. The method of claim 5 including causing said door to open by counterclockwise rotation.

8. A security drawer comprising:
a housing;
a tray reciprocatable in said housing;
a door to open and close said drawer, said door linked to the tray to open automatically when the tray moves outwardly; and
a lock to lock said door in a closed position.

9. The drawer of claim 8 wherein said lock includes a bar extending across said tray, said bar vertically reciprocable.

10. The drawer of claim 9 including a retainer to retain said bar in an upper unlocked position.

11. The drawer of claim 11 wherein said retainer includes a magnetic element.

12. The drawer of claim 8 wherein said tray includes curved edges to guide the opening of said door.

13. The drawer of claim 8 wherein said door to open by rotating counterclockwise.

14. The drawer of claim 13 wherein said drawer to open upwardly to a horizontal position over the tray.

15. The drawer of claim 8 including a sliding horizontal plate, said plate having an upstanding edge.

16. The drawer of claim 15 wherein said lock includes a horizontally positioned bar extending across said tray which in a first lower position blocks the rearward motion of said plate such that said plate abuts against said door.

17. A security drawer mountable in the wall of a building, said drawer comprising:
a housing;
a tray reciprocatable in said housing;
a door on the end of said drawer, said door to rotate in a counterclockwise direction over the top of said tray to open said drawer, said door linked to said tray to open automatically when the tray moves outwardly;
a bar extending across said tray, said bar mounted in a pair of spaced guides, said bar vertically displacable between a first position and a second position; and
a horizontal cover plate which may be locked against said door to prevent said door from opening when said bar is in said first position.

18. The drawer of claim 17 including a retainer to retain said bar in the second position within said housing.

19. The drawer of claim 18 wherein said retainer includes a magnetic element to magnetically hold said bar in said first position.

20. The drawer of claim 19 wherein said door is prevented by said tray from rotating in a clockwise direction.
